(19) United States
(12) Patent Application Publication
(10) Pub. No.: US 2022/0277264 A1
(43) Pub. Date: Sep. 1, 2022

(54) MERCHANDISE MANAGEMENT SYSTEM, MERCHANDISE MANAGEMENT METHOD, COMPUTER PROGRAM AND RECORDING MEDIUM

(71) Applicant: NEC Corporation, Minato-ku, Tokyo (JP)

(72) Inventors: Maya Takabatake, Tokyo (JP); Kazuki Miura, Tokyo (JP)

(73) Assignee: NEC Corporation, Minato-ku, Tokyo (JP)

(21) Appl. No.: 17/631,997

(22) PCT Filed: Jul. 30, 2020
(86) PCT No.: PCT/JP2020/029322

§ 371 Date: Feb. 1, 2022

(30) Foreign Application Priority Data
Aug. 5, 2019 (JP) 2019-143765

(51) Int. Cl. G06Q 10/08; B65G 1/137

(52) U.S. Cl. CPC G06Q 10/0875; B65G 1/137

(57) ABSTRACT

A merchandise management system includes: an acquisition unit that obtains a merchandise information, which is information about merchandise, from the merchandise in a store; a generation unit that generates store-side data, which are provided to a staff of the store, and customer-side data, which are provided to a customer who uses the store, on the basis of the merchandise information; and an output unit that outputs at least one of the store-side data and the customer-side data. This makes it possible to provide the store staff and the customer with appropriate information.

### TECHNICAL FIELD

The present invention relates to a merchandise management system, a merchandise management method, a computer program and a recording medium that manage commodities in a store.

### BACKGROUND ART

A known system of this type manages the position of merchandise, inventory information or the like, on the basis of information read from each article of merchandise in a store. For example, Patent Literatures 1 to 5 disclose a technique/technology of managing merchandise in a store by using information read from a RFID (Radio Frequency IDentifier) tag attached to each article of merchandise. Furthermore, in Patent Literatures 6 and 7 disclose a technique/technology of reading information from the RFID tag by using a robot.

### CITATION LIST

### Patent Literature

Patent Literature 1: JP2012-158455A

Patent Literature 2: JP2005-320074A

Patent Literature 3: JP2004-359363A

Patent Literature 4: JP2009-205481A

Patent Literature 5: JP2005-034358A

Patent Literature 6: JP2007-217069A

Patent Literature 7: JP2009-023740A

### SUMMARY

### Technical Problem

In the techniques/technologies as described in the Patent Literatures 1 to 5 described above, the information read from merchandise is outputted (e.g., displayed on a display or the like) to a store staff and a customer. However, the store staff and the customer require different information for a system. For example, the store staff requires information about the merchandise that is out of stock in order to replenish the stocks or perform similar actions, whereas the customer does not often require such information. On the other hand, the customer requires specific information about merchandise (e.g., information about materials, specifications, etc.), whereas the store staff does not often require such information. As a result, it is hardly possible to provide the store staff and the customer with appropriate information by merely outputting the information about merchandise, which is technically problematic.

In view of the problems described above, it is therefore an example object of the present invention to provide a merchandise management system, a merchandise management method, a computer program, and a recording medium that are configured to provide a store staff and a customer with appropriate information.

### Solution to Problem

A merchandise management system according to an example aspect of the present invention includes: an acquisition unit that obtains a merchandise information, which is information about merchandise, from the merchandise in a store; a generation unit that generates store-side data, which are provided to a staff of the store, and customer-side data, which are provided to a customer who uses the store, on the basis of the merchandise information; and an output unit that outputs at least one of the store-side data and the customer-side data.

A merchandise management method according to an example aspect of the present invention includes: an acquisition step that obtains a merchandise information, which is information about merchandise, from the merchandise in a store; a generation step that generates store-side data, which are provided to a staff of the store, and customer-side data, which are provided to a customer who uses the store, on the basis of the merchandise information; and an output step that outputs at least one of the store-side data and the customer-side data. A computer program according to an example aspect of the present invention allows a computer to execute: an acquisition step that obtains a merchandise information, which is information about merchandise, from the merchandise in a store; a generation step that generates store-side data, which are provided to a staff of the store, and customer-side data, which are provided to a customer who uses the store, on the basis of the merchandise information; and an output step that outputs at least one of the store-side data and the customer-side data.

On a recording medium according to an example aspect of the present invention, the computer program according to the example aspect described above is recorded.

### Advantageous Effects of Invention

According to the merchandise management system, the merchandise management method, the computer program, and the recording medium in the respective example aspects described above, it is possible to provide a store staff and a customer with appropriate information and to suitably manage merchandise.

### BRIEF DESCRIPTION OF DRAWINGS

FIG. 1 is a block diagram illustrating an overall configuration of a merchandise management system according to an example embodiment.

FIG. 2 is a block diagram illustrating a hardware configuration of a merchandise management apparatus according to the example embodiment.

FIG. 3 is a flowchart illustrating a flow of the operation of the merchandise management system according to the example embodiment.

FIG. 4 is a diagram illustrating an example of a case of displaying the position of an article of merchandise on a floor map as customer-side data.

FIG. 5 is a diagram illustrating an example of a case of displaying the position of the merchandise that is out of stock as store-side data.

FIG. 6 is a diagram illustrating an example of a case of displaying a list of information about merchandise as the store-side data.

### DESCRIPTION OF EXAMPLE EMBODIMENTS

Hereinafter, a merchandise management system, a merchandise management method, a computer program, and a recording medium according to an example embodiment will be described with reference to the drawings.

(System Configuration)

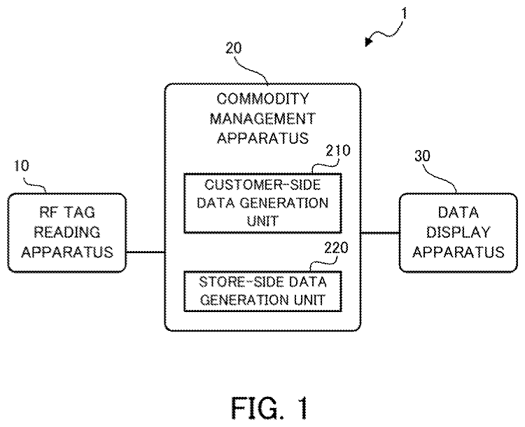

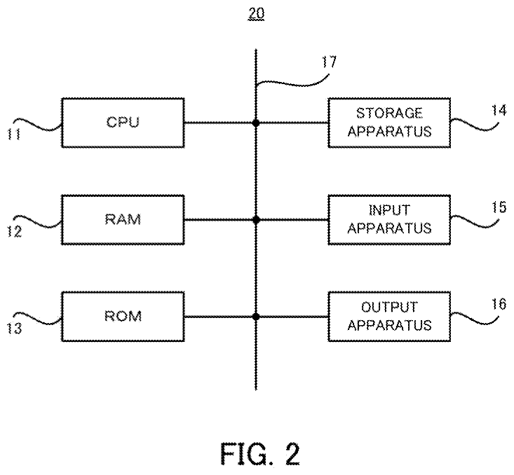

Firstly, a configuration of the merchandise management system according to the example embodiment will be described with reference to FIG. 1 and FIG. 2. FIG. 1 is a block diagram illustrating an overall configuration of the merchandise management system according to the example embodiment. FIG. 2 is a block diagram illustrating a hardware configuration of a merchandise management apparatus according to the example embodiment.

In FIG. 1, a merchandise management system 1 according to the example embodiment is a system that manages merchandise in a store, and includes an RF tag reading apparatus 10, a merchandise management apparatus 20, and a data display apparatus 30 as main components.

The RF tag reading apparatus 10 is configured to read (i.e., obtain) a merchandise information from a RFID tag attached to each article of merchandise (hereinafter referred to as an “RF tag” as occasion demands). The “merchandise information” herein is various types of information about merchandise and is stored in advance in the RF tag. An example of merchandise information includes a merchandise name, a merchandise type, a merchandise size, a merchandise color, a merchandise material, merchandise specifications, a merchandise position (e.g., a merchandise location) and the like. The RF tag reading apparatus 10 may be, for example, an apparatus that reads the RF tag by a store-side staff's operation, or may be an apparatus that performs an operation of automatically reading the RF tag, such as a self-propelled robot. The merchandise information read by the RF tag reading apparatus 10 is configured to be outputted to the merchandise management apparatus 20.

The merchandise information is not necessarily stored in the RF tag, and may be any information that can be read from merchandise itself or from a tag attached to merchandise. For example, the merchandise information may be given to merchandise as a code information that is a bar code or a QR code (registered trademark). In that case, the RF tag reading apparatus 10 may be configured as a code reading apparatus.

The merchandise management apparatus 20 is configured to generate customer-side data, which are to be provided to a customer of the store, and store-side data, which are to be provided to a store staff, on the basis of the merchandise information obtained by the RF tag reading apparatus 10. The merchandise management apparatus 20 includes a customer-side data generation unit 210 and a store-side data generation unit 220 as logical processing blocks or physical hardware.

The customer-side data generation unit 210 generates the customer-side data on the basis of the merchandise information. The customer-side data are generated for a customer who purchases merchandise at a store, and are generated, for example, by performing a process (e.g., imaging, sorting, and selection of information, etc.) for providing the customer with the information in an easy-to-understand manner, on various types of information included in the merchandise information. A specific example of the customer-side data will be described in detail later. The customer-side data generated by the customer-side data generation unit 210 are configured to be outputted to the data display apparatus 30.

The store-side data generation unit 220 generates the store-side data on the basis of the merchandise information. The store-side data are generated for a store staff (including not only a sales floor staff but also a staff of a management department, etc.), and are generated, for example, by performing a process (e.g., imaging, rearrangement, and rejection of information, etc.) for providing the store staff with such information in an easy-to-understand manner, on various types of information included in the merchandise information. A specific example of the store-side data will be described in detail later. The store-side data generated by the store-side data generation unit 220 are configured to be outputted to the data display apparatus 30.

As illustrated in FIG. 2, the merchandise management apparatus 20 according to the example embodiment includes a CPU (Central Processing Unit) 11, a RAM (Random Access Memory) 12, a ROM (Read Only Memory) 13, and a storage apparatus 14. The merchandise management apparatus 20 may further include an input apparatus 15 and an output apparatus 16. The CPU 11, the RAM 12, the ROM 13, the storage apparatus 14, the input apparatus 15, and the output apparatus 16 are connected through a data bus 17.

The CPU 11 reads a computer program. For example, the CPU 11 may read a computer program stored by at least one of RAM 12, ROM 13 and the storage apparatus 14. For example, the CPU 11 may read a computer program stored in a computer-readable recording medium, by using a not-illustrated recording medium reading apparatus. The CPU 11 may obtain (i.e., read) a computer program from a not-illustrated apparatus located outside the merchandise management apparatus 20, through a network interface. The CPU 11 controls the RAM 12, the storage apparatus 14, the input apparatus 15, and the output apparatus 16 by executing the read computer program. Especially in the example embodiment, when the CPU 11 executes the read computer program, a functional block for managing merchandise in the store is implemented in the CPU 11. In other words, the CPU 11 is configured to function as a controller for managing merchandise. The customer-side data generation unit 210 and the store-side data generation unit 220 described above are implemented in this CPU 11, for example.

The RAM 12 temporarily stores the computer program to be executed by the CPU 11. The RAM 12 temporarily stores the data that is temporarily used by the CPU 11 when the CPU 11 executes the computer program. The RAM 12 may be, for example, a D-RAM (Dynamic RAM).

The ROM 13 stores the computer program to be executed by the CPU 11. The ROM 13 may otherwise store fixed data. The ROM 13 may be, for example, a P-ROM (Programmable ROM).

The storage apparatus 14 stores the data that is stored for a long term by the merchandise management system 1. The storage apparatus 14 may operate as a temporary storage apparatus of the CPU 11. The storage apparatus 14 may include, for example, at least one of a hard disk apparatus, a magneto-optical disk apparatus, an SSD (Solid State Drive), and a disk array apparatus.

The input apparatus 15 is an apparatus that receives an input instruction from a user of the merchandise management system 1. The input apparatus 15 may include, for example, at least one of a keyboard, a mouse, and a touch panel.

The output apparatus 16 is an apparatus that outputs information about the merchandise management system 1 to the outside. For example, the output apparatus 16 may be a display apparatus that is configured to display the information about the merchandise management system 1.

Returning to FIG. 1, the data display apparatus 30 is configured as an apparatus including a display unit, such as, for example, a display unit, and displays at least one of the customer-side data and the store-side data generated by the merchandise management apparatus 20 (specifically, the customer-side data generation unit 210 and the store-side data generation unit 220). The data display apparatus 30 is configured, for example, as a digital signage installed in the store, or a terminal (e.g., a smartphone, etc.) owned by a customer, and displays the customer-side data to the customer in the store. Alternatively, the data display apparatus 30 is configured as a monitor installed in a checkout counter or a terminal (e.g., a tablet, etc.) owned by a store staff, and displays the store-side data to the store staff. Furthermore, the data display apparatus 30 is configured as a common terminal that can be used by both a customer and a store staff, and may be configured to switch between the customer-side data and the store-side data and display them.

The data display apparatus 30 may be configured to change a display aspect (display content, a display format, a hierarchy to be displayed, etc.) of the customer-side data or the store-side data in accordance with the operation of a customer or a store staff. The data display apparatus 30 may also output the customer-side data and the store-side data in another method (e.g., audio, etc.) in addition to or in place of displaying them. In other words, the form of the customer-side data and the store-side data is not limited to image data or text data, but may be in another form.

(Explanation of Operation)

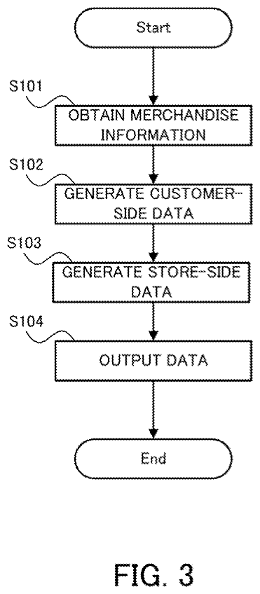

Next, a flow of the operation of the merchandise management system 1 according to the example embodiment will be described with reference to FIG. 3. FIG. 3 is a flowchart illustrating a flow of the operation of the merchandise management system according to the example embodiment.

As illustrated in FIG. 3, in operation of the merchandise management system 1 according to the example embodiment, firstly, the RF-tag reading apparatus 10 obtains the merchandise information from merchandise (step S101). The merchandise information is read typically during a time period when the store is closed (e.g., at nighttime, etc.). Specifically, after closing the store, the store staff operates the RF tag reading apparatus 10 to perform a reading operation of reading the merchandise information. Alternatively, the RF tag reading apparatus 10 that is configured as a self-propelled robot may automatically perform the reading operation of reading the merchandise information in an unattended condition in which a store staff has also left. Furthermore, the merchandise information may be read during business hours of the store (in other words, in a condition in which there is a customer in the store).

When the merchandise information is obtained, the customer-side data generation unit 210 generates the customer-side data on the basis of the obtained merchandise information (step S102). Furthermore, the store-side data generation unit 220 generates the store-side data on the basis of the obtained merchandise information (step S103). Incidentally, the step S102 and the step S103 may be performed one after another, or may be performed in parallel at the same time.

When the customer-side data and the store-side data are generated, at least one of them is outputted by the data display apparatus 30 (step S104). For example, the data display apparatus 30 displays the customer-side data and the store-side data as an image to a customer and a store staff. The data display apparatus 30 may output the customer-side data and the store-side data immediately after generating them, or may output the customer-side data and the store-side data, as occasion demands, in accordance with the operation of the customer and the store staff. Furthermore, the data display apparatus 30 may change the customer-side data and the store-side data to be automatically outputted, at each time when the customer-side data and the store-side data are newly generated (in other words, at each time when the customer-side data and the store-side data are updated).

(Display Example of Customer-Side Data)

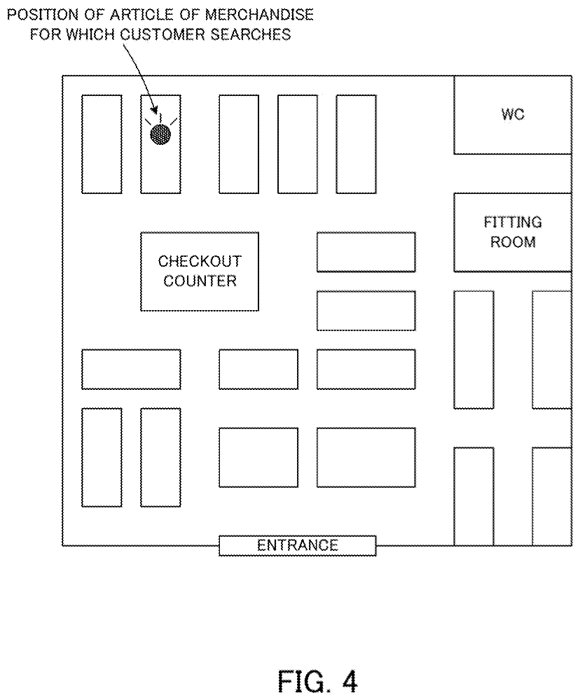

Next, a specific display example of the customer-side data will be described with reference to FIG. 4. FIG. 4 is a diagram illustrating an example of a case of displaying the position of an article of merchandise on a floor map as the customer-side data. In the following, an explanation will be given to a case where the merchandise management system 1 according to the example embodiment is applied to an apparel store (i.e., a clothing retailer) as an example.

As illustrated in FIG. 4, the customer-side data may be generated as data indicating the position of merchandise in the store. In this case, the data display apparatus 30 displays the floor map of the store and a mark (a black circle in FIG. 4) indicating the position of an article of merchandise for which a customer searches. If such customer-side data are displayed, it will be easier to find the merchandise that the customer wants to purchase. When there are a plurality of articles of merchandise in the store that match the customer's search condition, a plurality of marks may be displayed. In this case, the color and size of the mark may be changed for each article of merchandise.

Even when there is an article of merchandise for which the customer searches in the store, for example, if the article of merchandise is not yet displayed (e.g., the article is located in a place other than a display shelf, such as in a warehouse or on a passage), information about such an article of merchandise may not be displayed. In other words, information about merchandise that cannot be purchased by a customer may not be included in the customer-side data. Thus, if information about a predetermined article of merchandise that meets a preset condition is intentionally excluded from the customer-side data, it is possible to provide a customer with more appropriate information.

In addition, the customer-side data may include a coordination/style including merchandise for which a customer searches, an explanation on merchandise (materials, specifications, how to handle, etc.), reviews on merchandise (word of mouth), a screen linked to EC (Electronic Commerce) sites that sell merchandise in the store on the Internet, and the like.

(Display Example of Store-Side Data)

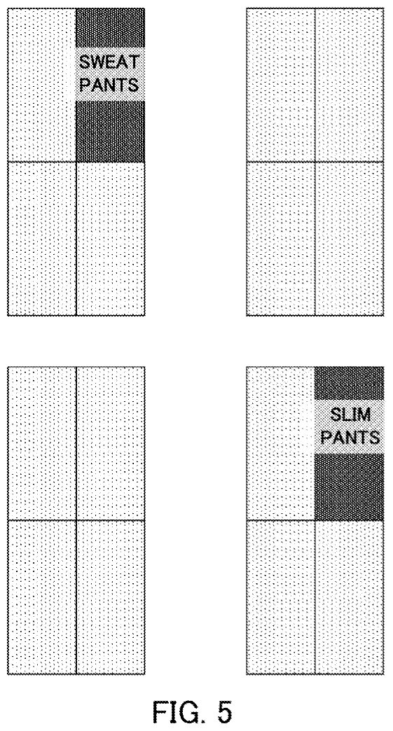

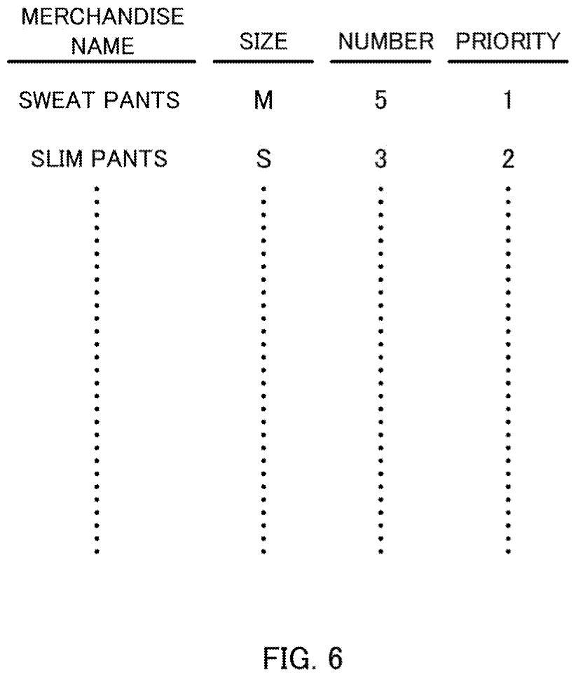

Next, a specific display example of the store-side data will be described with reference to FIG. 5 and FIG. 6. FIG. 5 is a diagram illustrating an example of a case of displaying the position of the merchandise that is out of stock as the store-side data. FIG. 6 is a diagram illustrating an example of a case of displaying a list of information about merchandise as the store-side data. Hereinafter, similarly to the example in FIG. 4, an explanation will be given to a case where the merchandise management system 1 according to the example embodiment is applied to an apparel store.

As illustrated in FIG. 5, the store-side data may be generated as data indicating the merchandise that is out of stock (i.e., the remaining number is zero or very few) in the store. In this case, the data display apparatus 30 displays images of different display aspects in accordance with whether or not there is stock out. In the example illustrated in FIG. 5, the shelf of the merchandise that is out of stock is displayed denser than the other shelves in which there is still in stock. In addition, specific merchandise names (here, “Sweat pants” and “Slim pants”) are displayed for the merchandise that is out of stock. If such store-side data are displayed, a store staff can intuitively know the type of the merchandise that is out of stock and the position of the merchandise that is out of stock. Therefore, it is possible to efficiently perform a replenishment work of the merchandise that is out of stock, or perform similar actions.

As illustrated in FIG. 6, the store-side data may be generated as data for displaying the merchandise that is handled in the store in a list format. Each article of merchandise on a list may be rearrangeable in accordance with various conditions. Alternatively, when it is intended to efficiently perform the replenishment work, a small remaining number (quantity) of articles of merchandise is automatically displayed in high order.

Furthermore, “priority” may be displayed as a guideline when performing the replenishment work. The priority herein may be set, for example, in consideration with not only the remaining number of articles of merchandise, but also sales of merchandise or the like. Specifically, for the merchandise that is a good seller (i.e., that is sold quickly), the priority of replenishment is set high even if the number of articles is relatively large (see, for example, “Sweat Pants” in FIG. 6), and for the merchandise that is a bad seller (i.e., that is sold slowly), the priority of replenishment may be set low even if the number of articles is relatively small (see, for example, “Slim Pants” in FIG. 6).

### Technical Effects

Next, technical effects obtained by the merchandise management system 1 according to the example embodiment will be described.

As described in FIG. 1 to FIG. 6, according to the merchandise management system 1 in the example embodiment, since the “customer-side data” and the “store-side data” are generated on the basis of the merchandise information, it is possible to output appropriate information to each of customers and a store staff. Therefore, compared with a case where the customer-side data and the store-side data are not separated (i.e., the same data is outputted to the customers and the store staff), it is possible to manage merchandise, more suitably.

Incidentally, the customer-side data and the store-side data described in the example embodiment are merely examples, and it is sufficient to generate separate data (i.e., the customer-side data and the store-side data), as occasion demands, in accordance with the type of merchandise handled by a store, the style of the store, or the like. The customer-side data and the store-side data may be at least partially different, or partially overlap with each other. Specifically, even if the customer-side data and the store-side data have the same display aspect, if the type and number of the merchandise information contained therein are different between a customer and a store staff, the above-described technical effects can be obtained accordingly. Alternatively, even if the customer-side data and the store-side data have the same type and number of merchandise information contained therein, the above-described technical effects can be obtained accordingly if the display aspects are partially different between the customer and the store staff.

<Supplementary Notes>

With respect to the example embodiment described above, the following Supplementary Notes will be further disclosed.

(Supplementary Note 1)

A merchandise management system described in Supplementary Note 1 is a merchandise management system including: an acquisition unit that obtains a merchandise information, which is information about merchandise, from the merchandise in a store; a generation unit that generates store-side data, which are provided to a staff of the store, and customer-side data, which are provided to a customer who uses the store, on the basis of the merchandise information; and an output unit that outputs at least one of the store-side data and the customer-side data.

(Supplementary Note 2)

A merchandise management system described in Supplementary Note 2 is the merchandise management system described in Supplementary Note 2, wherein the output unit is configured to switch between the store-side data and the customer-side data and output them.

(Supplementary Note 3)

A merchandise management system described in Supplementary Note 3 is the merchandise management system described in Supplementary Note 1 or 2, wherein the merchandise information includes information about a remaining number of articles of the merchandise in the store, and the generation unit generates at least one of the store-side data and the customer-side data as image data of different display aspects in accordance with the remaining number.

(Supplementary Note 4)

A merchandise management system described in Supplementary Note 4 is the merchandise management system described in any one of Supplementary Notes 1 to 3, wherein the generation unit generates the store-side data so as to include information indicating the merchandise that is to be replenished by the staff of the store.

(Supplementary Note 5)

A merchandise management system described in Supplementary Note 5 is the merchandise management system described in Supplementary Note 4, wherein the generation unit generates the store-side data so as to include information indicating priority of the merchandise that is to be replenished by the staff of the store.

(Supplementary Note 6)

A merchandise management system described in Supplementary Note 6 is the merchandise management system described in any one of Supplementary Notes 1 to 5, wherein the generation unit generates the customer-side data so as not to include information about a predetermined article of the merchandise that meets a preset condition.

(Supplementary Note 7)

The merchandise management system described in Supplementary Note 7 is the merchandise management system escribed in Supplementary Note 6, wherein the predetermined article is an article of the merchandise that is not yet displayed.

(Supplementary Note 8)

The merchandise management system described in Supplementary Note 8 is the merchandise management system described in any one of Supplementary Notes 1 to 7, wherein the acquisition unit is a self-propelled robot and automatically obtains the merchandise information.

(Supplementary Note 9)

A merchandise management method described in Supplementary Note 9 is a merchandise management method including: an acquisition step that obtains a merchandise information, which is information about merchandise, from the merchandise in a store; a generation step that generates store-side data, which are provided to a staff of the store, and customer-side data, which are provided to a customer who uses the store, on the basis of the merchandise information; and an output step that outputs at least one of the store-side data and the customer-side data.

(Supplementary Note 10)

A computer program described in Supplementary Note 10 is a computer program that allows a computer to execute: an acquisition step that obtains a merchandise information, which is information about merchandise, from the merchandise in a store; a generation step that generates store-side data, which are provided to a staff of the store, and customer-side data, which are provided to a customer who uses the store, on the basis of the merchandise information; and an output step that outputs at least one of the store-side data and the customer-side data.

(Supplementary Note 11)

A recording medium described in Supplementary Note 11 is a recording medium, wherein a computer program described in Supplementary Note 10 is recorded.

The present invention is not limited to the examples described above and is allowed to be changed, if desired, without departing from the essence or spirit of the invention which can be read from the claims and the entire specification. A merchandise management system, a merchandise management method, a computer program and a recording medium with such changes are also intended to be within the technical scope of the present invention.

To the extent permitted by law, this application is based upon and claims the benefit of priority from Japanese Patent Application No. 2019-143765, filed Aug. 5, 2019, and incorporates all of its disclosure herein.

Also, to the extent permitted by law, all the publications and articles described in the description are incorporated herein by reference.

### DESCRIPTION OF REFERENCE CODES

1 Merchandise management system
10 RF tag reading apparatus
20 Product control apparatus
30 Data display apparatus

What is claimed is:

1. A merchandise management system comprising:
at least one memory that is configured to store information; and
at least one processor that is configured to execute instructions
to obtain a merchandise information, which is information about merchandise, from the merchandise in a store;
to generate store-side data, which are provided to a staff of the store, and customer-side data, which are provided to a customer who uses the store, on the basis of the merchandise information; and
to output at least one of the store-side data and the customer-side data.

2. The merchandise management system according to claim 1, wherein the processor is configured to switch between the store-side data and the customer-side data and output them.

3. The merchandise management system according to claim 1, wherein
the merchandise information includes information about a remaining number of articles of the merchandise in the store, and
the processor generates at least one of the store-side data and the customer-side data as image data of different display aspects in accordance with the remaining number.

4. The merchandise management system according to claim 1, wherein the processor generates the store-side data so as to include information indicating the merchandise that is to be replenished by the staff of the store.

5. The merchandise management system according to claim 4, wherein the processor generates the store-side data so as to include information indicating priority of the merchandise that is to be replenished by the staff of the store.

6. The merchandise management system according to claim 1, wherein the processor generates the customer-side data so as not to include information about a predetermined article of the merchandise that meets a preset condition.

7. The merchandise management system according to claim 6, wherein the predetermined article is an article of the merchandise that is not yet displayed.

8. The merchandise management system according to claim 1, wherein the processor uses a self-propelled robot and automatically obtains the merchandise information.

9. A merchandise management method comprising:
obtaining a merchandise information, which is information about merchandise, from the merchandise in a store;
generating store-side data, which are provided to a staff of the store, and customer-side data, which are provided to a customer who uses the store, on the basis of the merchandise information; and
outputting at least one of the store-side data and the customer-side data.

10. A non-transitory recording medium on which a computer program that allows a computer to execute a merchandise management method,
the merchandise management method including:
obtaining a merchandise information, which is information about merchandise, from the merchandise in a store;
generating store-side data, which are provided to a staff of the store, and customer-side data, which are provided to a customer who uses the store, on the basis of the merchandise information; and
outputting at least one of the store-side data and the customer-side data.

11. (canceled)
